(19) United States
(12) Patent Application Publication
(10) Pub. No.: US 2026/0017356 A1
(43) Pub. Date: Jan. 15, 2026

(54) MACHINE LEARNING DEVICE, MACHINE LEARNING SYSTEM, AND MACHINE LEARNING METHOD

(71) Applicant: Hitachi, Ltd., Tokyo (JP)

(72) Inventors: Yusei SUZUKI, Tokyo (JP); Yosuke KAGA, Tokyo (JP); Kenta TAKAHASHI, Tokyo (JP)

(21) Appl. No.: 19/056,916

(22) Filed: Feb. 19, 2025

(30) Foreign Application Priority Data
Jul. 10, 2024 (JP) 2024-111129

(51) Int. Cl. G06F 21/32; G06V 10/44; G06V 10/74; G06V 10/774; G06V 40/16

(52) U.S. Cl. CPC G06F 21/32; G06V 10/44; G06V 10/761; G06V 10/774; G06V 40/171; G06V 40/172

(57) ABSTRACT

A machine learning device: updates a distribution parameter based on the actual environment attribute feature corresponding to biometric information on a target user; extracts an attribute feature from the updated distribution parameter; generate combined biometric information based on the extracted attribute feature and a training identification feature extracted from training biometric information; and updates a machine learning model based on the combined biometric information and the training biometric information, the attribute feature is a feature that has an influence on an authentication accuracy of biometric authentication and has a low correlation with an identification feature, and the identification feature is used for collation in the biometric authentication.

### CLAIM OF PRIORITY

The present application claims priority from Japanese patent application JP 2024-111129 filed on Jul. 10, 2024, the content of which is hereby incorporated by reference into this application.

### BACKGROUND OF THE INVENTION

The present invention is related to a machine learning device, a machine learning system, and a machine learning method.

Biometric authentication technology, in which personal authentication is performed based on an image of, for example, a face, a fingerprint, or an iris, is becoming widespread. Personal authentication is processing of verifying whether or not a user who is using a system is the same person as the user already registered in the system.

Generally, in biometric authentication, a comparison is performed between a registration-time feature extracted from the biometric information acquired at the time of registration and an authentication-time feature extracted from the biometric information acquired at the time of authentication. When the similarity between the registration-time feature and the authentication-time feature is equal to or higher than a predetermined threshold value, it is determined that the registered user and the authentication user are the same person.

Machine learning models are widely used to extract a feature from biometric information in order to perform authentication. The machine learning model is trained in advance by using a large amount of training data. When the acquisition environment of the training data used for training is significantly different from the actual environment during operation, performance deteriorates significantly.

As a related-art technology in this technical field for dealing with such problems, there is JP 2022-160144 A. The learning device in JP 2022-160144 A includes an acquisition module which acquires a first feature obtained by inputting an observation amount generated by a simulator into a neural network and a second feature obtained by inputting an observation amount obtained from the actual environment into a neural network, and a training module which trains the neural network by using an evaluation function that includes a difference between the first feature and the second feature.

In the technology as described in JP 2022-160144 A, it is required to use an observation amount acquired in the actual environment as the training data. That is, when a machine learning model for biometric authentication is to be trained by using the technology as described in JP 2022-160144 A, it is required to collect and accumulate biometric information obtained in the actual environment. Biometric information is sensitive personal information, and thus from the viewpoint of privacy protection, it is not desirable to collect and accumulate biometric information from the actual environment. In addition, users who are reluctant to provide biometric information may stop using the biometric authentication service.

### SUMMARY OF THE INVENTION

Thus, at least one aspect of this invention implements machine learning which uses biometric information that reflects an actual environment without collecting biometric information on a user in the actual environment.

The at least one aspect of this invention adopts the following structures in order to solve the above problems. A machine learning device includes: a processor; and a memory, wherein the memory holds: an actual environment attribute feature which is an attribute feature corresponding to biometric information on a target user; a distribution parameter indicating a distribution of the attribute feature; training biometric information which is the biometric information for training; and a machine learning model configured to output information indicating a feature of a living body when the biometric information is input, wherein the attribute feature is a feature that has an influence on an authentication accuracy of biometric authentication based on the biometric information, and has a low correlation with an identification feature extracted from the biometric information based on a predetermined condition, wherein the identification feature is a feature which is extracted from the biometric information and used for collation in the biometric authentication, and wherein the processor is configured to: update the distribution parameter based on the actual environment attribute feature; extract an attribute feature from the updated distribution parameter; extract, from the training biometric information, a training identification feature which is the identification feature for training; generate combined biometric information based on the extracted attribute feature and the training identification feature; and update the machine learning model based on the combined biometric information and the training biometric information.

The at least one aspect of this invention can implement machine learning which uses biometric information that reflects an actual environment without collecting biometric information on a user in the actual environment.

Problems, configurations, and effects which are not mentioned above are explained in the following embodiments.

### BRIEF DESCRIPTION OF THE DRAWINGS

FIG. 1 is a block diagram for illustrating a configuration example of a machine learning system according to the First Embodiment.

FIG. 2 is a block diagram for illustrating a hardware configuration example of a computer forming each of a client terminal and a server according to the First Embodiment.

FIG. 3 is a sequence diagram for illustrating an example of machine learning processing according to the First Embodiment.

FIG. 4 is a sequence diagram for illustrating an example of biometric authentication processing and machine learning processing according to the Second Embodiment.

FIG. 5 is a sequence diagram for illustrating an example of registration processing for biometric authentication processing according to the Second Embodiment.

### DETAILED DESCRIPTION OF THE PREFERRED EMBODIMENTS

In the following, embodiments of the present invention are explained referring the attached drawings. In the embodiments, the same configuration has the same reference letter, and repeated explanation are omitted. The embodiments are examples to achieve the present invention and do not limit a technical range of the present invention.

### First Embodiment

A machine learning system according to a first embodiment of this invention includes a client terminal and a server. The client terminal shares a biometric attribute feature extracted from biometric information on a user with the server, updates an attribute feature distribution parameter, generates combined biometric information for training based on an attribute feature sampled from the attribute feature distribution parameter and an identification feature extracted from training biometric information, and performs machine learning by using the training biometric information and the combined biometric information for training.

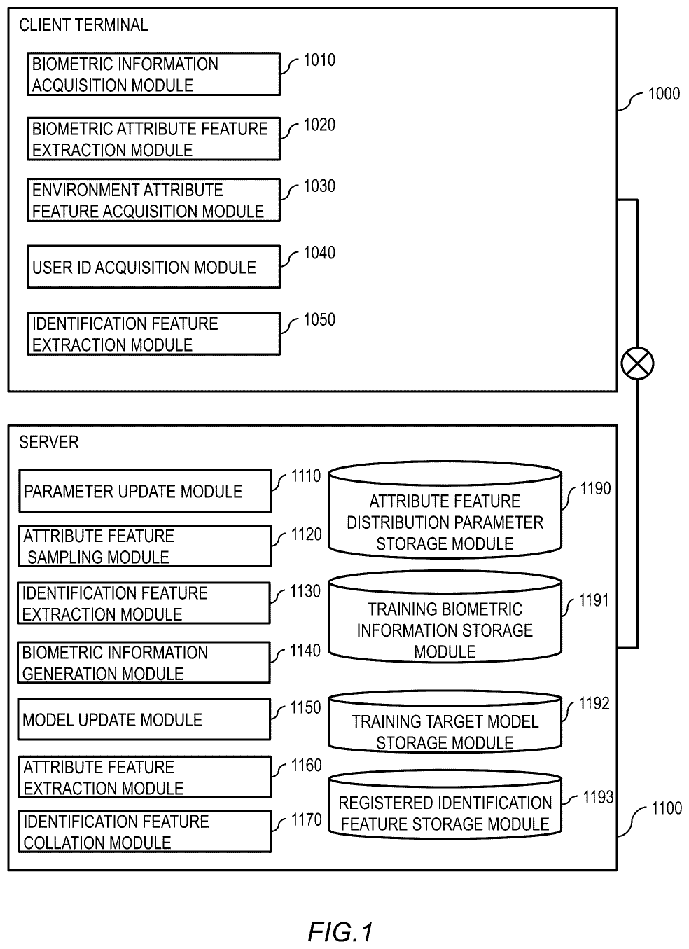

FIG. 1 is a block diagram for illustrating a configuration example of the machine learning system. The machine learning system includes, for example, a client terminal 1000 and a server 1100. The client terminal 1000 and the server 1100 are coupled to each other via a network such as the Internet. The machine learning system may include a plurality of client terminals 1000.

In FIG. 1, the client terminal 1000 includes, for example, a biometric information acquisition module 1010, a biometric attribute feature extraction module 1020, an environment attribute feature acquisition module 1030, a user ID acquisition module 1040, and an identification feature extraction module 1050, all of which are functional modules.

The biometric information acquisition module 1010 acquires biometric information on a user through an input device such as a sensor or a camera. The biometric information includes, for example, images showing a feature of a part of the body of the user, such as a face image, a fingerprint image, a palm vein image, and an iris image.

The biometric attribute feature extraction module 1020 extracts the biometric attribute feature from the biometric information acquired by the biometric information acquisition module 1010. The biometric attribute feature includes, for example, a feature indicating the direction and inclination of the face or the fingers, the color of the skin, the presence or absence of the wearing of an accessory and where the accessory is worn, the brightness and contrast of the biometric information in the image, and the like.

The biometric attribute feature is a feature extracted from biometric information. However, the biometric attribute feature is extracted separately from the identification feature. Further, because the biometric attribute feature is a feature extracted from biometric information, the biometric attribute feature may depend on the modality of the biometric information.

The environment attribute feature acquisition module 1030 acquires an environment attribute feature indicating the acquisition environment of the biometric information. The environment attribute feature includes, for example, a feature indicating the illuminance of the surrounding environment in which the client terminal 1000 is installed (environment in which the biometric information is acquired), the date and time of acquisition, position information on the client terminal 1000, the shop in which the client terminal 1000 is installed, the ID of the client terminal 1000, and the like.

The environment attribute feature is, for example, information acquired from a device installed in an environment in which biometric information is acquired. Specifically, for example, the environment attribute feature is acquired from information registered in advance on the client terminal 1000, a setting of a sensor (camera) which captures biometric information, or a sensor different from the sensor which captures biometric information (for example, an illumination sensor). The environmental attribute feature differs from the biometric attribute feature in that the environmental attribute feature is acquired from an information source other than biometric information.

The biometric information feature and the environment attribute feature may hereinafter be collectively referred to simply as “attribute features.” The attribute features are features that have an influence on the authentication accuracy of biometric authentication which uses biometric information acquired by the biometric information acquisition module 1010. Meanwhile, it is not possible to identify a person only from attribute features. Specifically, for example, the attribute features are features having a low correlation with the identification feature, which is described later, based on a predetermined condition (for example, the correlation coefficient is lower than a predetermined threshold value (or the correlation coefficient is lower than a predetermined first threshold value and higher than a predetermined second threshold value)). It should be noted that the similarity of attribute features extracted respective pieces of biometric information on a plurality of people having similar attributes is high.

The user ID acquisition module 1040 acquires, for example, in accordance with input from the user to an input device, a user ID capable of uniquely identifying the user. The user ID is described by, for example, a character string composed of alphanumeric characters.

The identification feature extraction module 1050 extracts an identification feature for identifying a person from the biometric information acquired by the biometric information acquisition module 1010. The identification feature is a feature used for collation during biometric authentication, and is information that enables a person to be easily identifiable. Generally, the similarity between identification features extracted from a plurality of pieces of biometric information on the same person is higher than the similarity between identification features extracted from pieces of biometric information on different people.

The client terminal 1000 in the first embodiment is not required to include the user ID acquisition module 1040 and the identification feature extraction module 1050.

The server 1100, which is an example of a machine learning device, includes, for example, a parameter update module 1110, an attribute feature sampling module 1120, an identification feature extraction module 1130, a biometric information generation module 1140, a model update module 1150, an attribute feature extraction module 1160, and an identification feature collation module 1170, all of which are functional modules.

The server 1100 includes, for example, an attribute feature distribution parameter storage module 1190, a training biometric information storage module 1191, a training target model storage module 1192, and a registered identification feature storage module 1193, all of which are storage modules in which information is stored.

The parameter update module 1110 updates the attribute feature distribution parameter based on the attribute features received from the client terminal 1000 and an attribute feature distribution parameter stored in the attribute feature distribution parameter storage module 1190.

The attribute feature distribution is a probability distribution in which the value of the attribute feature is a random variable. Any probability distribution can be adopted as the attribute feature distribution. Specifically, for example, the type of the probability distribution is determined in advance for each type of attribute feature, and information indicating the type of the probability distribution may also be stored in the attribute feature distribution parameter storage module 1190. The attribute feature distribution parameters are parameters which determine the shape of the probability distribution. For example, when the attribute feature distribution is a multidimensional normal distribution, the attribute feature distribution parameters include a mean vector and a covariance matrix.

The attribute feature distribution parameters stored in the attribute feature distribution parameter storage module 1190 may be, for example, parameters generated only in accordance with an attribute feature acquired by the client terminal 1000 (attribute feature acquired in the actual operating environment), or may be parameters which are given a predetermined initial value and then updated by using an attribute feature acquired by the client terminal 1000.

When the client terminal 1000 extracts or acquires a plurality of types of attribute features, different attribute feature distribution parameters may be set for each different type of attribute feature.

Further, the attribute feature distribution parameters may be managed for each client terminal 1000 and/or for each user ID. That is, an attribute feature distribution may be defined for each client terminal 1000, an attribute feature distribution may be defined for each user ID, or an attribute feature distribution may be defined for each combination of a client terminal 1000 and a user ID.

For example, when the attribute feature distribution parameters are managed for each ID of a client terminal 1000, for each piece of position information on a client terminal 1000 when the client terminal 1000 is a stationary terminal, for each shop ID in which a client terminal 1000 is installed, and the like, the server 1100 can obtain the attribute features corresponding to the client terminal 1000 installed in a specific shop.

When the server 1100 also receives information indicating the shop in which the client terminal 1000 is installed in Step S2510, which is described later, it becomes possible for the server 1100 to perform machine learning specific to the actual environment of the shop by executing combined biometric information generation processing in Step S2570 described later by using only an attribute feature sampled from the attribute feature distribution determined based on the attribute feature distribution parameters corresponding to the client terminal 1000 installed in a specific shop.

The attribute feature sampling module 1120 samples the attribute feature from the attribute feature distribution determined based on the attribute feature distribution parameters stored in the attribute feature distribution parameter storage module 1190.

For example, when it is assumed that there is a multidimensional vector representing the brightness of the biometric information as the attribute feature, that this vector follows a multidimensional normal distribution, and that a mean vector μ and a covariance matrix Σ are stored as attribute feature distribution parameters, in this case the attribute feature sampling module 1120 can sample the attribute feature by generating random numbers that follow a multidimensional normal distribution having the mean vector μ and the covariance matrix Σ.

The identification feature extraction module 1130 extracts the identification feature from the training biometric information stored in the training biometric information storage module 1191. The biometric information generation module 1140 combines the attribute feature sampled by the attribute feature sampling module 1120 and the identification feature of the training biometric information extracted by the identification feature extraction module 1130 to generate combined biometric information, and stores the generated combined biometric information in the training biometric information storage module 1191.

The model update module 1150 updates the machine learning model based on the training biometric information which includes the combined biometric information stored in the training biometric information storage module 1191 and the machine learning model stored in the training target model storage module 1192. Any general machine learning model may be adopted as the machine learning model, such as a linear regression model, a decision tree, or a neural network.

The machine learning model stored in the training target model storage module 1192 is a model that outputs information indicating a feature of a living body when biometric information is input. Specifically, for example, the machine learning model may be a model that outputs an identification feature when biometric information is input, or a model that outputs, when biometric information that is an image is input, a converted image of the image (a converted image which includes the biometric feature).

The attribute feature extraction module 1160 extracts the biometric attribute feature and/or the environment attribute feature from the biometric information stored in the training biometric information storage module 1191. The identification feature collation module 1170 collates the identification feature included in a registration template registered in the registered identification feature storage module 1193 and the identification feature extracted from the biometric information acquired by the client terminal 1000, and outputs the authentication result.

It should be noted that the server 1100 in the first embodiment is not required to include the identification feature collation module 1170 and the registered identification feature storage module 1193.

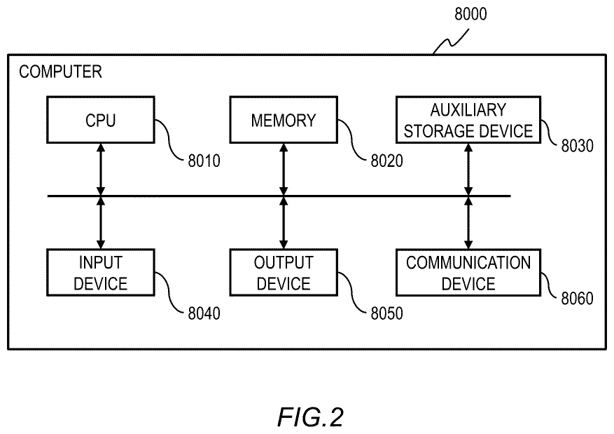

FIG. 2 is a block diagram for illustrating a hardware configuration example of a computer forming each of the client terminal 1000 and the server 1100. A computer 8000 includes, for example, a central processing unit (CPU) 8010, a memory 8020, an auxiliary storage device 8030, an input device 8040, an output device 8050, and a communication device 8060.

The CPU 8010 is an example of a processor, and executes a program stored in the memory 8020. The memory 8020 includes a read only memory (ROM), which is a nonvolatile memory device, and a random access memory (RAM), which is a volatile memory device. The ROM stores, for example, an invariant program (for example, basic input/output system (BIOS)). The RAM is a dynamic random access memory (DRAM) or other such high-speed and volatile memory device, and temporarily stores a program to be executed by the CPU 8010 and data to be used when the program is executed by the CPU 8010.

The auxiliary storage device 8030 is, for example, a large-capacity and nonvolatile storage device such as a magnetic storage device (hard disk drive (HDD)) and a flash memory (solid state drive (SSD)). Programs to be executed by the CPU 8010 and data to be used when the programs are executed by the CPU 8010 are stored in the auxiliary storage device 8030. Specifically, the programs are read out from the auxiliary storage device 8030, loaded onto the memory 8020, and executed by the CPU 8010.

All or some of the programs executed by the CPU 8010 may be provided to the computer 8000 from a removable medium (such as a CD-ROM or a flash memory) being a non-transitory storage medium or from an external computer including a non-transitory storage device via a network, and may then be stored in the nonvolatile auxiliary storage device 8030 being a non-transitory storage medium. Thus, it is preferred that the computer 8000 include an interface which reads data from the removable medium.

The CPU 8010 of the computer 8000 forming the client terminal 1000 includes the biometric information acquisition module 1010, the biometric attribute feature extraction module 1020, the environment attribute feature acquisition module 1030, the user ID acquisition module 1040, and the identification feature extraction module 1050, which are the above-mentioned functional modules of the client terminal 1000.

The CPU 8010 of the computer 8000 forming the server 1100 includes the parameter update module 1110, the attribute feature sampling module 1120, the identification feature extraction module 1130, the biometric information generation module 1140, the model update module 1150, the attribute feature extraction module 1160, and the identification feature collation module 1170, which are the above-mentioned functional modules of the server 1100.

For example, the CPU 8010 of the computer 8000 forming the client terminal 1000 operates in accordance with a biometric information acquisition program loaded on the memory 8020 of the computer 8000 forming the client terminal 1000 to function as the biometric information acquisition module 1010, and operates in accordance with a biometric attribute feature extraction program loaded on the memory 8020 to function as the biometric attribute feature extraction module 1020. For each of the other function modules included in the CPU 8010 of the computer 8000 forming the client terminal 1000, a relationship between a program and the function module is also the same. For each of the function modules included in the CPU 8010 of the computer 8000 forming the server 1100 as well, a relationship between a program and the function module is also the same.

The auxiliary storage device 8030 of the computer 8000 forming the server 1100 provides a storage area for implementing the attribute feature distribution parameter storage module 1190, the training biometric information storage module 1191, and the training target model storage module 1192, which are the above-mentioned storage modules of the server 1100. The data stored in each storage module is accumulated as data on the auxiliary storage device 8030. A part or all of the information stored in each storage module may be stored in the memory 8020 or may be stored in an external device coupled to the computer 8000.

The information used by the machine learning system does not depend on the data structure and may be expressed in any data structure. For example, a suitably selected data structure from among tables, lists, databases, or queues can store the information.

The input device 8040 includes a device, such as a keyboard, a touch panel, a smart device, or a mouse, which receives input from the user. Moreover, the input device 8040 includes a device, such as a biometric sensor, a scanner, or a camera, which is used by the biometric information acquisition module 1010 to acquire biometric information.

The output device 8050 is a device, such as a display, a printer, a touch panel, or a smart device, which outputs an execution result of a program in a form visually recognizable by the user. The communication device 8060 is a network interface device which controls communication to and from another device in accordance with a predetermined protocol. Further, the communication device 8060 may include, for example, a serial interface such as a universal serial bus (USB).

Each of the client terminal 1000 and the server 1100 is a computer system physically formed on one computer 8000 or formed on a plurality of computers 8000 that are configured logically or physically, and may be operated on separate threads on the same computer 8000, or may operate on a virtual machine built on a plurality of physical computer resources.

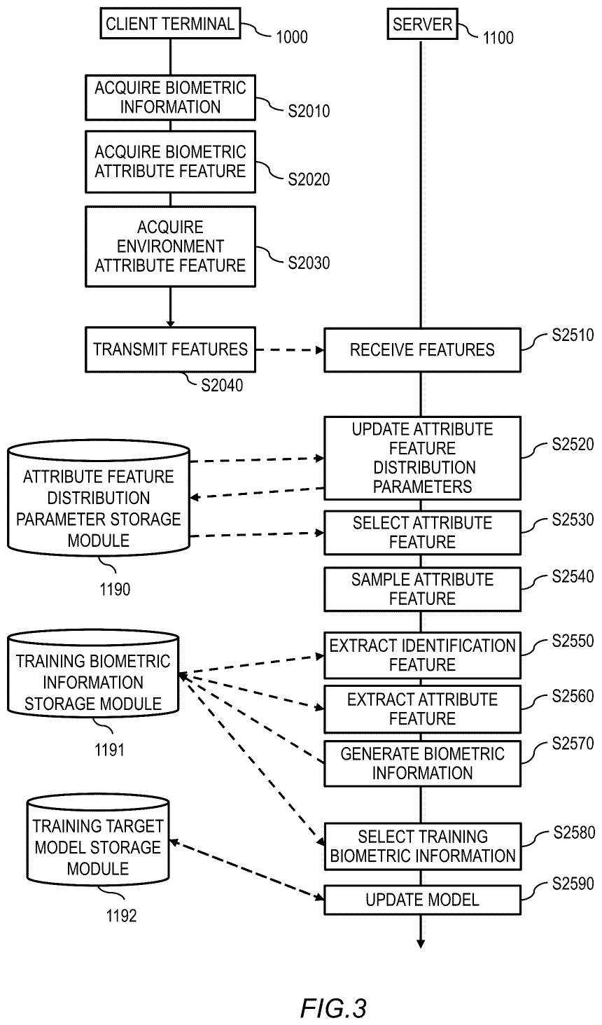

FIG. 3 is a sequence diagram for illustrating an example of machine learning processing. In the example of FIG. 3, machine learning that reflects attribute information on an actual environment (for example, the environment in which the client terminal 1000 is used) is executed. In the first embodiment, machine learning is performed by sharing attribute features between two parties, namely, the client terminal 1000 and the server 1100.

It is assumed that before the processing of FIG. 3 starts, information indicating at least the type of the attribute feature distribution is stored (when the processing of FIG. 3 has already been executed one or more times, the attribute feature distribution parameters are also already stored) in the attribute feature distribution parameter storage module 1190, the training biometric information is stored in the training biometric information storage module 1191, and the machine learning model is stored in the training target model storage module 1192.

The biometric information acquisition module 1010 of the client terminal 1000 acquires biometric information (biometric information having the same modality as that of the training biometric information) from the user (an example of a target user) (S2010). The biometric information is data used for the personal authentication that the first embodiment is directed to, and includes the above-mentioned images indicating physical features, for example, the fingerprint, the face, the iris, and the veins and information indicating behavioral features such as acceleration information, a movement history, a browsing history, and a purchase history.

The acquisition of the biometric information in Step S2010 may be executed only for the purpose of the collection of the attribute features or for the purpose of the authentication of the attribute features in addition to or instead of the collection of the attribute features. The client terminal 1000 may be a personal terminal that is exclusively used by one specific user, such as a personal computer (PC), a smartphone, or a tablet terminal, or may be a shared terminal used by a large number of users that is installed in a specific shop or the like.

The biometric attribute feature extraction module 1020 of the client terminal 1000 extracts the biometric attribute feature from the biometric information acquired in Step S2010 (S2020).

The biometric attribute feature indicates a feature based on biometric information. The biometric attribute feature is a feature that is extracted separately from the identification feature used for biometric authentication, and it is difficult to identify a person from the biometric attribute feature alone. In addition, among a plurality of biometric attribute features extracted from the biometric information on a plurality of people acquired in the same environment, some of those biometric attribute features tend to have a higher similarity.

As described above, the biometric attribute feature includes, for example, a feature indicating the direction and inclination of the face or the fingers, the presence or absence of the wearing of an accessory, and the like. In addition, when the biometric information is acquired as an image, the biometric attribute feature may include a feature indicating, for example, the brightness and contrast of the biometric portion (face, fingers, palm, iris, and the like) in the image.

Among those examples of the biometric attribute feature, the direction and inclination of the face or the fingers, and the brightness and contrast of the biometric portion depend on the installation environment of the client terminal 1000 acquiring the biometric information, and thus tend to have a higher similarity when acquired in the same environment. Further, for example, hair and skin color often vary depending on the country or region, and are the biometric attribute feature which tends to have a higher similarity when acquired in the same environment.

The biometric attribute feature extraction module 1020 can update the machine learning model in a way that further prevents a person from being easily identifiable by collecting the biometric attribute feature and updating the attribute feature distribution parameters in a manner that focuses only on a biometric attribute feature that has a high similarity with other people in the same environment. The type of the biometric attribute feature having a high similarity may be determined in advance or may be determined by the client terminal 1000. When the client terminal 1000 determines the type of the biometric attribute feature having a high similarity, for each biometric attribute feature of the same type, for example, the average value of the distance of each value extracted in the past may be calculated, and a biometric attribute feature of a type having a small average value may be determined as the type of the biometric attribute feature having a high similarity.

The environment attribute feature acquisition module 1030 of the client terminal 1000 acquires the environment attribute feature based on the acquisition environment of the biometric information (S2030). Regarding information that has a high degree of invariance, such as the terminal ID of the client terminal 1000 and the position information (for example, when the client terminal 1000 is a stationary terminal in a shop), the environment attribute feature acquisition module 1030 may hold the information acquired for the first time in the auxiliary storage device 8030, and is not required to acquire this information each time Step S2010 is performed. The processing step of Step S2020 and the processing step of Step S2030 may be executed in any order. Further, one of the processing step of Step S2020 and the processing step of Step S2030 may not be executed, and in this case, the attribute feature corresponding to the processing which is not executed is not transmitted in Step S2040.

The client terminal 1000 transmits the biometric attribute feature extracted in Step S2020 and the environment attribute feature acquired in Step S2030 to the server 1100 (S2040). The biometric attribute feature and the environment attribute feature acquired by the client terminal 1000 are examples of an actual environment attribute feature.

The server 1100 receives the biometric attribute feature and the environment attribute feature transmitted from the client terminal 1000 in Step S2040 (S2510).

The parameter update module 1110 updates the attribute feature distribution parameter, which is stored in the attribute feature distribution parameter storage module 1190, corresponding to each attribute feature based on the biometric attribute feature and environment attribute feature received from the client terminal 1000 in Step S2510, and stores the updated attribute feature distribution parameters in the attribute feature distribution parameter storage module 1190 (S2520).

For example, when the attribute feature distribution parameters are managed separately for each type of attribute feature such as the terminal ID and position information on the client terminal 1000, the parameter update module 1110 updates the attribute feature distribution parameters in accordance with the type of the attribute feature received from the client terminal 1000 in Step S2510.

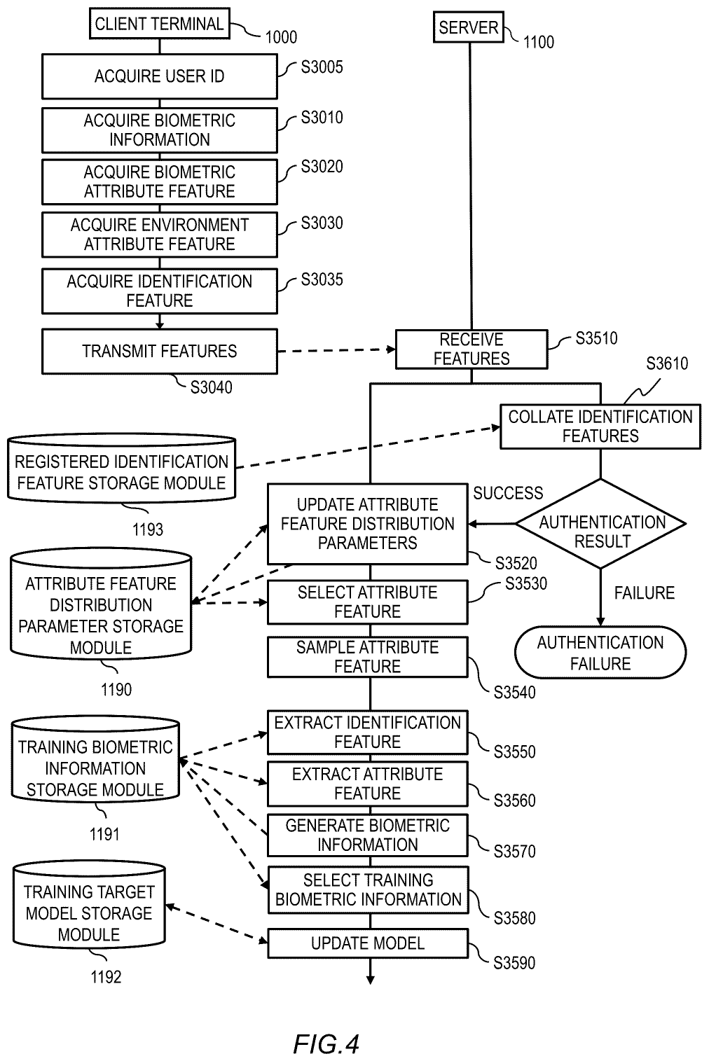

When the attribute feature distribution parameters are managed for each user ID, the parameter update module 1110 may use the authentication result of biometric authentication to update the attribute feature distribution parameter corresponding to the user ID having the attribute feature transmitted from the client terminal 1000. An example of using the authentication result of biometric authentication is described later in a second embodiment of this invention with reference to FIG. 4.

The attribute feature sampling module 1120 selects the attribute feature(s) to be sampled, and acquires the attribute feature distribution parameters of the selected attribute feature(s) from the attribute feature distribution parameter storage module 1190 (S2530).

At this time, the attribute feature sampling module 1120 may acquire only the attribute feature distribution parameters corresponding to the types of the attribute features updated in Step S2520, may acquire only the other attribute feature distribution parameters, or may acquire both. Further, the attribute feature sampling module 1120 may acquire only the attribute feature distribution parameters corresponding to the types of the attribute features designated by an administrator, for example, of the machine learning system.

The attribute feature sampling module 1120 samples a freely-selectable number (for example, a number designated by the administrator of the machine learning system, or a randomly determined number) of attribute features from each attribute feature distribution parameter acquired in Step S2530 (S2540). In Step S2540, the attribute feature sampling module 1120 may include the values of the attribute features received in Step S2510 in the sampling result in order to ensure that the values of the attribute features received in Step S2510 are reflected in the update of the machine learning model.

The identification feature extraction module 1130 of the server 1100 acquires the training biometric information from the training biometric information storage module 1191, and extracts the identification feature from the acquired training biometric information (S2550).

The attribute feature extraction module 1160 of the server 1100 acquires the training biometric information from the training biometric information storage module 1191, and extracts the biometric attribute feature and/or the environment attribute feature from the acquired training biometric information (S2560). It is acceptable that only one of the biometric attribute feature and the environmental attribute feature is extracted in Step S2560. The types of attribute features to be extracted in Step S2560 are designated by the administrator, for example, of the machine learning system.

The training biometric information to be acquired by the identification feature extraction module 1130 and the attribute feature extraction module 1160 may be all the training biometric information stored in the training biometric information storage module 1191, or training biometric information designated by the administrator, for example, of the machine learning system. The processing step of Step S2550 and the processing step of Step S2560 may be executed in any order.

Further, when the attribute features of the training biometric information are not used in the processing described below, the processing step of Step S2560 is not required to be executed. Specifically, for example, in a case in which, among the attribute features, only an environment attribute feature in which the presence or absence of the wearing of an accessory is indicated by 1 or 0 is used in the processing described below, and in the attribute feature sampling processing of Step S2540, both values of 1 and 0 indicating the presence or absence of the wearing of an accessory are obtained, it is not required to acquire the value of the environment attribute feature indicating the presence or absence of the wearing of an accessory from the training biometric information in Step S2560, and thus the processing step of Step S2560 can be omitted.

The biometric information generation module 1140 generates, for each identification feature extracted in Step S2550, combined biometric information by reflecting the values of the attribute features extracted in Step S2560 and the attribute features sampled in Step S2540, and stores the generated combined biometric information in the training biometric information storage module 1191 (S2570).

Specifically, for example, when the biometric information is a face image, the biometric information generation module 1140 can, in Step S2570, reflect attribute features representing the direction of the face, the color of the skin and the hair, facial surface shading, and the presence or absence of a certain accessory such as glasses or a mask in the identification feature extracted from the face image (training biometric information) of a certain person, to thereby generate a face image of the certain person that has a combination of values of those attributes.

Further, the types of the attribute features sampled in Step S2540 and the types of attribute features extracted in Step S2560 may be partially different. Specifically, for example, when an attribute feature representing facial surface shading is sampled in Step S2540, and the attribute features other than the attribute feature representing facial surface shading are extracted from the training biometric information in Step S2560, in Step S2570, regarding facial surface shading, the biometric information generation module 1140 can reflect only the information (the value sampled from the attribute feature distribution) acquired in the actual operating environment in the training biometric information.

When an image generation model is used to generate the combined biometric information in Step S2570, the attribute features that can be input to the image generation model are different depending on the characteristics of the image generation model. At this time, the system administrator can freely determine, depending on the purpose of training, whether or not to use the attribute feature sampled in Step S2540 and/or the attribute features extracted from the training biometric information in Step S2560 as the attribute features that can be input to the image generation model.

The model update module 1150 selects and acquires the biometric information to be used for training from the training biometric information storage module 1191 (S2580). Specifically, for example, the model update module 1150 randomly selects a predetermined number of pieces of training biometric information from the training biometric information storage module 1191.

Further, for example, the model update module 1150 may calculate an evaluation value indicating an authentication accuracy for each piece of training biometric information stored in the training biometric information storage module 1191, and select training biometric information having a high evaluation value based on a predetermined condition (for example, training biometric information having an evaluation value that is equal to or higher than a predetermined threshold value, or a predetermined number of pieces of training biometric information in descending order of evaluation value), select training biometric information having a low evaluation value based on a predetermined condition (for example, training biometric information having an evaluation value that is less than a predetermined threshold value, or a predetermined number of pieces of training biometric information in ascending order of evaluation value), or select training biometric information having an evaluation value that is within a predetermined range (for example, a range determined by a predetermined upper limit and lower limit).

Further, for example, the model update module 1150 may calculate an evaluation value based on the distance between pieces of training biometric information or an evaluation value indicating authentication accuracy for a set of pieces of training biometric information, and select the training biometric information by repeating exclusion of training biometric information based on this evaluation value (for example, training biometric information having a high evaluation value based on a predetermined condition may be excluded, training biometric information having a low evaluation value based on a predetermined condition may be excluded, or training biometric information having an evaluation value that is not within a predetermined range may be excluded).

In addition, in a case in which the machine learning model is a model for extracting an identification feature, when the distance between the identification feature extracted from the biometric information and a representative identification feature for each person to be used during training is too close, the effectiveness of the training is low, and when this distance is too far, training becomes difficult. For this reason, by calculating, for example, the distance between the identification feature extracted from the training biometric information and the representative identification feature of the person to which the biometric information to be used during the training belongs, and retaining only the data on people for which this distance is included in a predetermined range, the model update module 1150 can be expected to perform efficient and highly accurate training.

Further, for example, the model update module 1150 may calculate, for the attribute features used when combined biometric information is generated, an evaluation value indicating the authentication accuracy of the combined biometric information generated by using those attribute features, and select training biometric information having a high evaluation value based on a predetermined condition, select training biometric information having a low evaluation value based on a predetermined condition, or select training biometric information having an evaluation value that is within a predetermined range.

For example, when the performance of the machine learning model deteriorates when an attribute feature is changed, the performance of the model can be expected to be improved by focusing the sampling on training biometric information having an attribute feature that is included in the range of the change.

Further, for example, the model update module 1150 may include the combined biometric information generated in Step S2570 in the selection result of Step S2580 in order to ensure that the combined biometric information generated in Step S2570 is reflected in the update of the machine learning model.

The model update module 1150 updates the machine learning model based on the machine learning model acquired from the training target model storage module 1192 and the biometric information acquired in Step S2580, and stores the updated machine learning model in the training target model storage module 1192 (S2590).

For example, when the machine learning model to be updated is a neural network that outputs an identification feature when a face image is input, ideally, all of the identification features obtained as the output when a freely-selected face image of one person is input to the model are equal.

In this case, the model update module 1150 can update the machine learning model by adopting the sum of the square of the distances between identification features of the same person as a loss function and minimizing the value of the loss function. Further, the model update module 1150 can also update the machine learning model by generating a representative identification feature for each person, defining a loss function based on the distance between the representative identification feature and each identification feature other than the representative identification feature for each person, and minimizing the loss function.

The model update module 1150 can generate the representative identification feature by calculating a predetermined statistical amount such as an average value or a median value for a set of identification features generated by inputting a plurality of face images of the same person into the machine learning model.

When the distance between the identification features of given two people is small, it is difficult to distinguish the two people from each other by using those identification features, and hence ideally the distance between the identification features of any two people is large (for example, equal to or more than a predetermined value). Therefore, it is also effective for the model update module 1150 to update the machine learning model by defining a loss function in which the value decreases as the distance between the identification features or the representative identification features of different people becomes smaller, and minimizing the value of the loss function.

When this training is performed in a way that is suitable for biometric information that reflects the attribute features obtained from the actual operating environment, the training method can be performed by, for example, minimizing a loss function that is based on the distance from the identification feature which is output when the combined biometric information generated in Step S2570 is input to an identification feature that has a small distance from the other identification features of the same person and/or to an identification feature from which the person is easily identified.

Further, the machine learning model may be used in different ways in accordance with an environment attribute feature or a biometric attribute feature. For example, by defining the machine learning model that corresponds to a terminal ID included in an environment attribute feature, a machine learning model that specializes in biometric information having an attribute feature obtained based on the terminal ID can be trained and built.

As described above, the machine learning system according to the first embodiment can perform machine learning that is based on attribute information obtained from biometric information on an actual environment acquired by the client terminal 1000 without collecting the biometric information on the actual environment in the server 1100. In other words, the machine learning system according to the first embodiment can improve performance of a machine learning model for personal authentication by adapting the machine learning model for personal authentication to the actual environment without collecting the biometric information on the user itself.

### Second Embodiment

The machine learning system according to the first embodiment manages a biometric attribute feature and an environment attribute feature obtained during biometric authentication independently of the authentication result, and uses those attribute features to update attribute feature distribution parameters in order to perform machine learning. However, there may be cases in which it is desirable to sample an attribute feature of a specific user.

Further, by defining a dedicated attribute feature distribution parameter for each user ID, when a user having a low authentication success rate is found, the biometric information generated by using the relevant attribute feature distribution parameter of the user or the attribute feature sampled from the relevant attribute feature distribution parameter can also be used as auxiliary information for identifying the cause of the low authentication success rate.

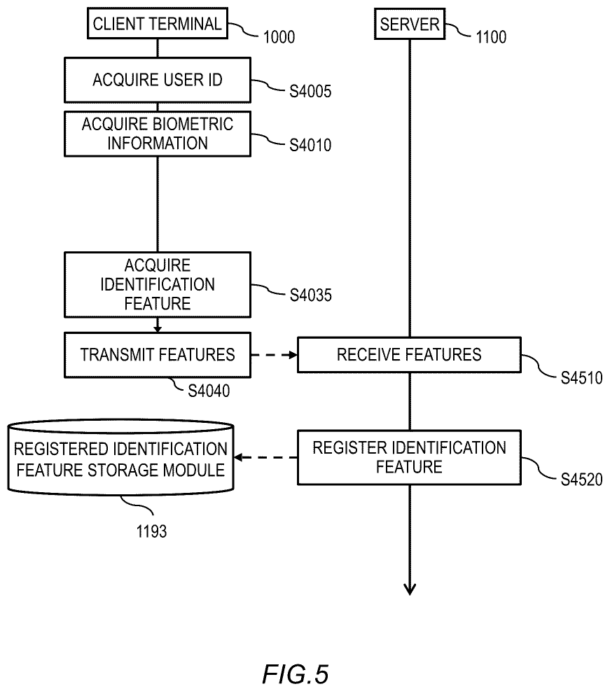

In view of this background, a machine learning system according to the second embodiment manages, for each user ID, a biometric attribute feature, an environment attribute feature, and attribute feature distribution parameters, generates biometric information, and updates a machine learning model, based on the authentication result of biometric authentication. The machine learning system according to the second embodiment executes the processing of FIG. 4 and FIG. 5 in place of the processing of FIG. 3. Differences of the processing in the second embodiment from the processing in the first embodiment are mainly described below.

FIG. 4 is a sequence diagram for illustrating an example of biometric authentication processing and machine learning processing. In the processing of FIG. 4, the attribute feature distribution parameters are managed for each user ID based on a collation result of biometric authentication. Compared to the first embodiment, the second embodiment includes additional processing for performing biometric authentication.

The user ID acquisition module 1040 of the client terminal 1000 acquires a user ID (S3005). Specifically, for example, the user ID acquisition module 1040 acquires a user ID through user input such as keyboard input, reading of a two-dimensional code by a camera or a scanner, or reading of an IC card.

When 1:N authentication, in which all registered users are identified as targets without requiring input of a user ID or the like, is adopted as the biometric authentication method, the processing step of Step S3005 is not required to be executed.

The processing steps of Step S3010, Step S3020, and Step S3030 are the same as the processing steps of Step S2010, Step S2020, and Step S2030, respectively, in the first embodiment.

The identification feature extraction module 1050 of the client terminal 1000 extracts the identification feature from the biometric information acquired in Step S3010 (S2035). A multidimensional vector obtained by inputting the biometric information into a machine learning model such as a neural network trained for personal identification and information on a specific pattern and feature points extracted from an image containing biometric information are both examples of the identification feature.

The client terminal 1000 transmits the user ID acquired in Step S3005, the biometric attribute feature acquired in Step S3020, the environment attribute feature acquired in Step S3030, and the identification feature acquired in Step S3035 to the server 1100 (S3040). The server 1100 receives the user ID, the biometric attribute feature, the environment attribute feature, and the identification feature transmitted from the client terminal 1000 in Step S3040 (S3510).

The identification feature collation module 1170 of the server 1100 collates the identification feature received in Step S3510 with the registered identification feature stored in the registered identification feature storage module 1193 (S3610).

When 1:1 authentication is adopted as the biometric authentication method (when the processing step of Step S3010 has been performed), in Step S3610, the identification feature collation module 1170 collates the identification feature received in Step S3510 and the registered identification feature that is linked to the user ID received in Step S3510 among the registered identification features stored in the registered identification feature storage module 1193. Further, when 1:N authentication is adopted as the biometric authentication method (when the processing step of Step S3010 has not been performed), in Step S3610, the identification feature collation module 1170 collates, for example, the identification feature received in Step S3510 and each registered identification feature stored in the registered identification feature storage module 1193.

In Step S3610, the identification feature collation module 1170 performs collation by using, for example, dissimilarity based on the distance between identification features. In this case, the identification feature collation module 1170 calculates, for example, the Hamming distance or Euclidean distance between identification features as the dissimilarity. The identification feature collation module 1170 applies thresholding or the like to the calculated dissimilarity to determine an authentication result indicating authentication success or authentication failure.

The value that the identification feature collation module 1170 calculates for collation is not limited to a continuous value such as similarity or dissimilarity. For example, when template protection technology is applied to biometric information to generate a template as the identification feature, the identification feature collation module 1170 obtains a binary value indicating any one of authentication success or authentication failure as the collation result. In this case, the identification feature collation module 1170 is not required to execute the above-mentioned thresholding, and outputs the collation result as the authentication result.

The attribute feature sampling module 1120 receives the authentication result output in Step S3610, and when the authentication is successful, uses the biometric attribute feature and the environment attribute feature received in Step S3510 to update the attribute feature distribution parameter linked to the user ID of the user successfully authenticated (S3520). Through the above-mentioned processing, the attribute feature distribution parameters can be managed and updated in association with the user ID, and the attribute features can be sampled on a user-by-user basis.

The processing steps of Step S3530, Step S3540, Step S3550, Step S3560, Step S3570, Step S3580, and Step S3590 are the same as the processing steps of Step S2530, Step S2540, Step S2550, Step S2560, Step S2570, Step S2580, and S2590, respectively, in the first embodiment.

As described above, in the second embodiment, attribute information obtained in the actual operating environment can be reflected in biometric information that can be used in existing learning, and a high-performance machine learning model which captures differences in attribute features on a user-by-user basis can be trained.

When the authentication in Step S3610 fails, the processing of FIG. 4 may be ended, and in Step S3520, the attribute feature sampling module 1120 may use the biometric attribute feature and environment attribute feature received in Step S3510 to update the attribute feature distribution parameters that are managed without distinguishing the users, and then execute the processing steps of Step S3530 and the subsequent steps.

FIG. 5 is a sequence diagram for illustrating an example of registration processing for biometric authentication processing. It is desired that the processing of FIG. 5 be executed before the processing of FIG. 4. The processing steps of Step S4005, Step S4010, and Step S4035 of FIG. 5 are the same as the processing steps of Step S3005, Step S3010, and Step S3035 of FIG. 4, respectively. However, the identification feature extracted as the registered identification feature in Step S4035 may be different from the identification feature during authentication which is extracted in Step S3035. In addition, the processing step of Step S4005 is not omitted.

The client terminal 1000 transmits the user ID acquired in Step S4005 and the identification feature acquired in Step S4035 to the server 1100 (S4040). The server 1100 receives the identification feature and the user ID transmitted from the client terminal 1000 in Step S4040 (S4510), and stores the received identification feature and user ID in association with each other in the registered identification feature storage module 1193 (S4520).

When the above-mentioned template is used as a collation target with the identification feature during authentication, the server 1100 generates a registration template from the identification feature received in Step S4510, and stores the generated registration template in the registered identification feature storage module 1193 in association with the user ID received in S4510. The registration template is information that can be collated with the identification feature obtained during authentication. It should be noted that the server 1100 may apply a predetermined template protection technology when the template is generated, to thereby apply measures for preventing the leakage of the original identification feature and biometric information from the registration template.

Through the execution of the processing of FIG. 5, personal authentication can be performed based on the processing steps of from Step S3005 to Step S3040 by the client terminal 1000 and from Step S3510 to Step S3610 by the server 1100 in FIG. 4.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, and processors, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD (Solid State Drive), or a storage medium such as an IC card, or an SD card.

The drawings show control lines and information lines as considered necessary for explanations but do not show all control lines or information lines in the products. It can be considered that almost of all components are actually interconnected.

What is claimed is:

1. A machine learning device, comprising:
a processor; and
a memory,
wherein the memory holds:
an actual environment attribute feature which is an attribute feature corresponding to biometric information on a target user;
a distribution parameter indicating a distribution of the attribute feature;
training biometric information which is the biometric information for training; and
a machine learning model configured to output information indicating a feature of a living body when the biometric information is input,
wherein the attribute feature is a feature that has an influence on an authentication accuracy of biometric authentication based on the biometric information, and has a low correlation with an identification feature extracted from the biometric information based on a predetermined condition,
wherein the identification feature is a feature which is extracted from the biometric information and used for collation in the biometric authentication, and
wherein the processor is configured to:
update the distribution parameter based on the actual environment attribute feature;
extract an attribute feature from the updated distribution parameter;
extract, from the training biometric information, a training identification feature which is the identification feature for training;
generate combined biometric information based on the extracted attribute feature and the training identification feature; and
update the machine learning model based on the combined biometric information and the training biometric information.

2. The machine learning device according to claim 1,
wherein the memory holds:
an authentication identification feature which is the identification feature extracted from the biometric information on the target user;
the distribution parameter corresponding to each of a plurality of users including the target user; and
a registered identification feature which is the identification feature corresponding to the target user and being registered in advance, and
wherein the processor is configured to:
execute authentication of the target user by collating the authentication identification feature and the registered identification feature; and
update, when it is determined that the target user has been successfully authenticated, the distribution parameter corresponding to the target user based on the actual environment attribute feature.

3. The machine learning device according to claim 1,
wherein the memory holds:
information indicating a target shop at which the biometric information on the target user is acquired; and
the distribution parameter corresponding to each of a plurality of shops, and
wherein the processor is configured to update the distribution parameter corresponding to the target shop based on the actual environment attribute feature.

4. The machine learning device according to claim 1, wherein the attribute feature includes an environment attribute feature which indicates an acquisition environment of the biometric information and is acquired from a device installed in the acquisition environment of the biometric information.

5. The machine learning device according to claim 4, wherein the environment attribute feature includes at least one of a date and time at which the biometric information is acquired, an illuminance obtained when the biometric information is acquired, or information on a position at which the biometric information is acquired.

6. The machine learning device according to claim 1, wherein the attribute feature includes a biometric attribute feature extracted from the biometric information.

7. The machine learning device according to claim 6, wherein the biometric attribute feature includes, when the biometric information is an image of a part of a body of a user, at least one of a direction of the part of the body included in the image, an inclination of the part of the body included in the image, a color of the part of the body included in the image, presence or absence of an accessory included in the image, a wearing position of the accessory included in the image, a brightness of the part of the body included in the image, or a contrast of the part of the body included in the image.

8. The machine learning device according to claim 6, wherein the biometric attribute feature is a feature that has a high similarity based on a predetermined condition when the biometric attribute feature is extracted from the biometric information acquired in the same environment.

9. The machine learning device according to claim 1, wherein the machine learning model is configured to output the identification feature when the biometric information is input.

10. A machine learning system, comprising;
a client terminal, and
a server:
wherein the client terminal holds an actual environment attribute feature which is an attribute feature corresponding to biometric information on a target user;
wherein the server holds:
a distribution parameter indicating a distribution of the attribute feature;
training biometric information which is the biometric information for training; and
a machine learning model configured to output information indicating a feature of a living body when the biometric information is input,
wherein the attribute feature is a feature that has an influence on an authentication accuracy of biometric authentication based on the biometric information, and has a low correlation with an identification feature extracted from the biometric information based on a predetermined condition,
wherein the identification feature is a feature which is extracted from the biometric information and used for collation in the biometric authentication,
wherein the client terminal is configured to transmit the actual environment attribute feature to the server, and
wherein the server is configured to:
update the distribution parameter based on the actual environment attribute feature;
extract an attribute feature from the updated distribution parameter;
extract, from the training biometric information, a training identification feature which is the identification feature for training;
generate combined biometric information based on the extracted attribute feature and the training identification feature; and
update the machine learning model based on the combined biometric information and the training biometric information.

11. A machine learning method by a machine learning device,
wherein the machine learning device includes a processor and a memory,
wherein the memory holds:
an actual environment attribute feature which is an attribute feature corresponding to biometric information on a target user;
a distribution parameter indicating a distribution of the attribute feature;
training biometric information which is the biometric information for training; and
a machine learning model configured to output information indicating a feature of a living body when the biometric information is input,
wherein the attribute feature is a feature that has an influence on an authentication accuracy of biometric authentication based on the biometric information, and has a low correlation with an identification feature extracted from the biometric information based on a predetermined condition, and
wherein the identification feature is a feature which is extracted from the biometric information and used for collation in the biometric authentication,
the machine learning method comprising:
updating, by the processor, the distribution parameter based on the actual environment attribute feature;
extracting, by the processor, an attribute feature from the updated distribution parameter;
extracting, by the processor, from the training biometric information, a training identification feature which is the identification feature for training;
generating, by the processor, combined biometric information based on the extracted attribute feature and the training identification feature; and
updating, by the processor, the machine learning model based on the combined biometric information and the training biometric information.
